(19) United States
(12) Patent Application Publication
(10) Pub. No.: US 2025/0026487 A1
(43) Pub. Date: Jan. 23, 2025

(54) LIGHTNING STRIKE INDUCTION SYSTEM AND METHOD

(71) Applicant: Nippon Telegraph and Telephone Corporation, Tokyo (JP)

(72) Inventors: Toshihisa MASUDA, Musashino-shi, Tokyo (JP); Jun KATO, Musashino-shi, Tokyo (JP); Masato MARUYAMA, Musashino-shi, Tokyo (JP)

(21) Appl. No.: 18/713,268

(22) PCT Filed: Dec. 7, 2021
(86) PCT No.: PCT/JP2021/044954

§ 371 Date: May 24, 2024

(51) Int. Cl. B64D 45/02; B64U 20/83; B64U 50/34; B64U 50/35; H02G 13/00; H02H 9/04

(52) U.S. Cl. CPC B64D 45/02; B64U 20/83; B64U 50/34; B64U 50/35; H02G 13/40; H02H 9/044

(57) ABSTRACT

A flight object included in a Faraday cage, a power supply unit included in the Faraday cage and supplies power to the flight object, a first voltage-dependent switch connected between the Faraday cage and one of power supply lines that supplies power to the power supply unit, a second voltage-dependent switch connected between the Faraday cage and the other of power supply lines, a power supply device provided at an end of the power supply line on the ground surface side, a third voltage-dependent switch connected between one output terminal of the power supply device and the ground, and a fourth voltage-dependent switch connected between the other output terminal of the power supply device and the ground.

### TECHNICAL FIELD

The present invention relates to a lightning guiding system and a method thereof.

### BACKGROUND ART

As weather becomes more extreme and lightning strikes become more common, research and development of a technique for controlling lightning and eliminating lightning damage to people and equipment have been conducted.

One such study was conducted to capture a lightning strike and safely lead the lightning strike to the ground by flying a drone including a lightning rod and a guide line having one end portion grounded (Non Patent Literature 1). Note that, for the purpose of enhancing lightning resistance of a drone against a direct lightning strike, a lightning guiding system that covers the drone with a Faraday gauge has been proposed (Non Patent Literature 2).

In addition, in order to solve the problem that the operating time of the drone is short, a drone that wire-feeds power from the ground is sold (Non Patent Literature 3).

### CITATION LIST

### Non Patent Literature

Non Patent Literature 1: [retrieved on Nov. 16, 2021], the Internet <URL: https://monoist.atmarkit.co.jp/mn/articles/2011/20/news052. html>
Non Patent Literature 2: Toshihisa Masuda and four other persons, “Drone no tairaisei kojo ni kansuru kisoteki kento” (in Japanese) (Basic Study on Improvement of Lightning Resistance of Drone), The Institute of Electronics, Information and Communication Engineers, Society Convention, B-4-6, pp. 179, 2021 Non Patent Literature 3: [retrieved on Nov. 16, 2021], the Internet <URL: https://hovering.co.jp/unyo/aeroboonair/>

### SUMMARY OF INVENTION

### Technical Problem

However, in a case where the conventional technique described above is used to capture lightning by flying a drone while constantly supplying power, there is a problem that a current due to a lightning surge flows via the drone and a guide line or a power supply line, and the drone is damaged or falls.

The present invention has been made in view of this problem, and an object of the present invention is to provide a lightning guiding system and a method thereof in which, in a case where a drone is caused to fly while constantly supplying power to capture lightning, a current due to a lightning surge flowing through the drone is suppressed, and the drone is prevented from being damaged or falling.

### Solution to Problem

A lightning guiding system according to an aspect of the present invention includes a flight object that is included in a Faraday cage, a power supply unit that is included in the Faraday cage and supplies power to the flight object, a first voltage-dependent switch that is connected between the Faraday cage and one of power supply lines for supplying power to the power supply unit, a second voltage-dependent switch that is connected between the Faraday cage and another of the power supply lines, a power supply device that is provided at an end portion of the power supply line on a ground surface side, a third voltage-dependent switch that is connected between one output terminal of the power supply device and the ground, and a fourth voltage-dependent switch that is connected between the other output terminal of the power supply device and the ground.

In addition, a lightning guiding method according to an aspect of the present invention includes causing a flight object to fly between a lightning originating point in midair where lightning occurs and a ground surface, supplying power to the flight object by a power supply unit, guiding a lightning surge from lightning that has struck a Faraday cage including the flight object and the power supply unit to the ground via a first voltage-dependent switch connected between the Faraday cage and one of power supply lines that supply power to the power supply unit and a third voltage-dependent switch connected between the one of the power supply lines and the ground, or guiding the lightning surge to the ground via a second voltage-dependent switch connected between another of the power supply lines supplying power to the power supply and a fourth voltage-dependent switch connected between the other of the power supply lines and the ground.

### Advantageous Effects of Invention

According to the present invention, it is possible to provide a lightning guiding system and a method thereof in which, in a case where a flight object (drone) is caused to fly while constantly supplying power to capture lightning, a current due to a lightning surge flowing through the flight object is suppressed, and the flight object is prevented from being damaged or falling.

### BRIEF DESCRIPTION OF DRAWINGS

FIG. 1 is a diagram schematically illustrating a configuration example of a lightning guiding system according to an embodiment of the present invention.

FIG. 2 is a diagram illustrating a connection relationship between a Faraday cage and a power supply device illustrated in FIG. 1.

FIG. 3 is a diagram illustrating another example of the connection relationship illustrated in FIG. 2.

FIG. 4 is a flowchart illustrating a processing procedure of a lightning guiding method performed by the lightning guiding system illustrated in FIG. 1.

### DESCRIPTION OF EMBODIMENTS

Hereinafter, embodiments of the present invention will be described with reference to the drawings. The same reference signs will be given to the same components in a plurality of drawings, and description thereof will not be repeated.

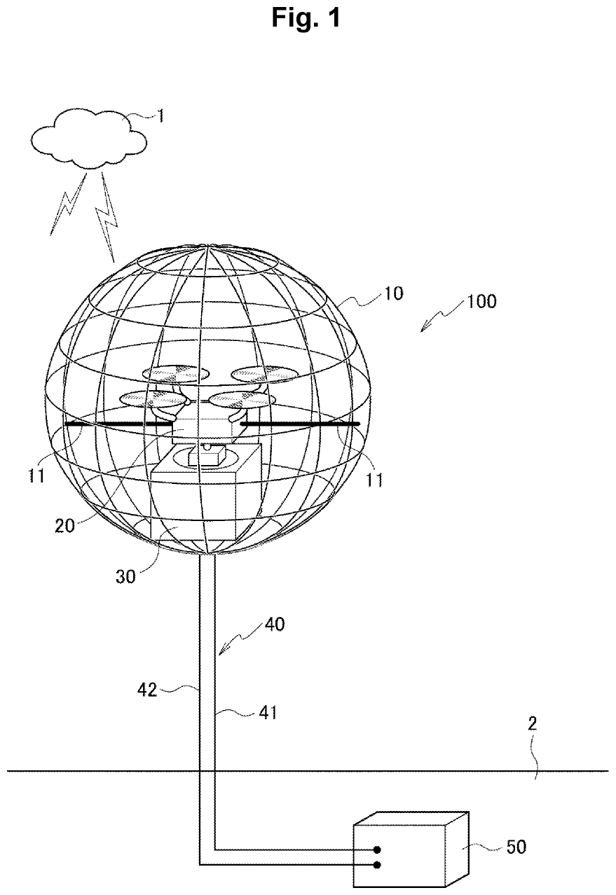

FIG. 1 is a diagram schematically illustrating a configuration example of a lightning guiding system according to an embodiment of the present invention. A lightning guiding system 100 illustrated in FIG. 1 suppresses a current due to a lightning surge flowing through a flight object (drone), and prevents the flight object from being damaged and falling. The lightning surge is a harmful overvoltage or overcurrent instantaneously generated at the time of a lightning strike.

The lightning guiding system 100 includes a Faraday cage 10, a flight object 20, a power supply unit 30, a power supply line 40 (one supply line 41 and another supply line 42), and a power supply device 50.

The Faraday cage 10 is a space surrounded by conductors, or a conductor basket or vessel to be used to create such a space. When lightning strikes the Faraday cage, electric power lines cannot enter the inside of the Faraday cage 10 surrounded by the conductor, and therefore, the external electric field is blocked and the potential inside is all kept equal.

The flight object 20 is included in the Faraday cage 10 and flies between a lightning originating point 1 that generates lightning and a ground surface 2 together with the Faraday cage 10. The flight object 20 is fixed to the Faraday cage 10 by, for example, two pillars 11.

The flight object 20 is a wireless flight object generally called a drone, and normally flies by remote control performed by a drone pilot (not shown) on the ground. The flight object 20 and the remote controller (not illustrated) being operated by the drone pilot are wirelessly connected.

The power supply unit 30 is included in the Faraday cage 10 and supplies power to the flight object 20. Power to be supplied to the flight object 20 is supplied from a power supply device 50 disposed on the ground surface 2 via the power supply line 40.

The power supply unit 30 supplies power to the flight object 20 by, for example, wireless power supply. The wireless power supply is performed by magnetically coupling a power transmission coil (not illustrated) and a power reception coil (not illustrated). The power transmission coil is incorporated in the power supply unit 30, and the power reception coil is incorporated in the flight object 20. The power transmission coil and the power reception coil are disposed apart from each other by, for example, about several centimeters.

The power supply line 40 connects the power supply device 50 disposed on the ground surface 2 and the power supply unit 30, and supplies power from the power supply device 50 to the power supply unit 30. The power supply line 40 allows an alternating current (alternating current) that generates a magnetic field in the power transmission coil to flow. The AC current is a current whose magnitude and direction periodically change from the one supply line 41 to the other supply line 42 of the power supply line 40 or from the other supply line 42 to one supply line 41. The length of the power supply line 40 is such that the flight object 20 can be brought close to the lightning originating point 1 in the sky at which lightning is generated.

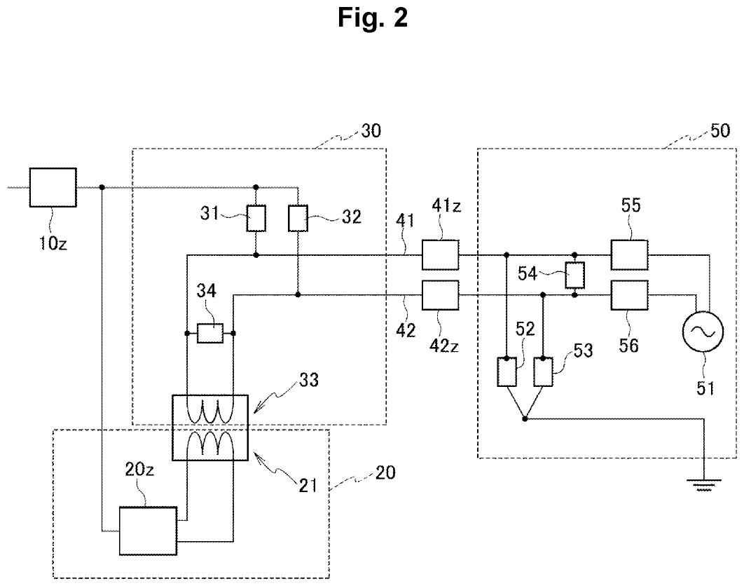

FIG. 2 is a diagram illustrating a connection relationship between the Faraday cage 10 and the power supply device 50. A block 10z at the left end illustrated in FIG. 2 represents the impedance of the Faraday cage 10.

A block 20z at the lower end illustrated in FIG. 2 represents the impedance of the flight object 20 fixed to the Faraday cage 10 with the pillar 11 (FIG. 1). As illustrated in FIG. 1, the flight object 20 is fixed to the Faraday cage 10 by, for example, two pillars 11. The power reception coil 21 incorporated in the flight object 20 faces the power transmission coil 33 of the power supply unit 30.

As illustrated in FIG. 1, the housing of the power supply unit 30 is connected and fixed to the Faraday cage 10. The power transmission coil 33 is disposed inside the power supply unit 30 (housing).

One end of the power transmission coil 33 is connected to one supply line 41 of the power supply line 40. The other end of the power transmission coil 33 is connected to the other supply line 42 of the power supply line 40.

The one supply line 41 and the housing of the power supply unit 30 are connected via a first voltage-dependent switch 31 such as a two-electrode gas discharge tube (GDT) or a varistor. The other supply line 42 and the housing of the power supply unit 30 are similarly connected via the second voltage-dependent switch 32.

The first and second voltage-dependent switches 31 and 32 are elements having a voltage-current characteristic in which a current suddenly flows out at a certain constant voltage. The constant voltage is set to a value lower than a lightning surge of lightning that strikes the Faraday cage 10.

The power transmission coil 33 is connected to the power supply device 50 via the one supply line 41 and the other supply line 42. Impedances 41z and 42z of the supply lines 41 and 42 are distributed constants distributed over the entire supply lines 41 and 42, respectively, but are expressed here by lumped constants (blocks 41z and 42z) for convenience of explanation.

The power supply device 50 includes a power source 51 that causes an alternating current to flow through the power transmission coil 33 via the supply lines 41 and 42. The supply line 41 before being connected to the power source 51 is grounded via the third voltage-dependent switch 52. Similarly, the supply line 42 before being connected to the power source 51 is grounded via the fourth voltage-dependent switch 53. The third and fourth voltage-dependent switches 52 and 53 are the same as the first and second voltage-dependent switches 31 and 32.

The power transmission coil 33 through which the alternating current flows generates a magnetic field. The magnetic field is magnetically coupled to the power reception coil 21. Then, power can be transmitted to the power reception coil 21 by electromagnetic induction. That is, the flight object 20 is supplied with power from the power supply unit 30 via the electric power line. With the electric power, the flight object 20 rotates the propeller to generate lift and fly.

Power transmission by this electromagnetic coupling method is common. Since a gap of about several cm is provided between the power transmission coil 33 and the power reception coil 21, the impedance viewed from the Faraday cage 10 is larger on the power reception coil 21 side than on the first and second voltage-dependent switches 31 and 32 side.

Here, it is assumed that lightning strikes the Faraday cage 10. Then, the lightning surge is guided to the ground via the first voltage-dependent switch 31, the impedance 41z, and the third voltage-dependent switch 52. Alternatively, the lightning surge is guided to ground via the second voltage-dependent switch 31, the impedance 42z, and the fourth voltage-dependent switch 53.

As a result, a harmful overvoltage due to the lightning surge is not applied to the flight object 20 represented by the impedance 20z. Therefore, the flight object 20 is prevented from being damaged by the lightning surge.

Note that the filters 55 and 56 connected between the terminals of the power source 51 and the supply lines 41 and 42 block the frequency component of the lightning surge. In a case where the frequency component of lightning is assumed to be, for example, 30 MHz, the filters 55 and 56 are configured by a band-stop filter that blocks the frequency. Alternatively, when the frequency of the AC current supplied from the power source 51 to the power transmission coil 33 is lower than the frequency component of lightning, a low-pass filter that passes a frequency lower than 30 MHz may be used.

The fifth voltage-dependent switch 54 that connects the supply lines 41 and 42 inside the power supply device 50 is the same as the first voltage-dependent switch 31 to the fourth voltage-dependent switch 53, and protects the power source 51.

The sixth voltage-dependent switch 34 connected in parallel to the power transmission coil 33 inside the power supply unit 30 is the same as the fifth voltage-dependent switch 54 and protects the power transmission coil 33.

The lightning surge is guided to ground via the first voltage-dependent switch 31 and the third voltage-dependent switch 52, or the second voltage-dependent switch 32 and the fourth voltage-dependent switch 53. Therefore, the filters 55 and 56, the fifth voltage-dependent switch 54, and the sixth voltage-dependent switch 34 may be omitted.

The flight object 20 and the Faraday cage 10 may be connected via an insulator (not illustrated). The impedance when viewing the flight object 20 side from the Faraday cage 10 can be further increased, and the lightning surge resistance performance can be improved.

### Modification Example

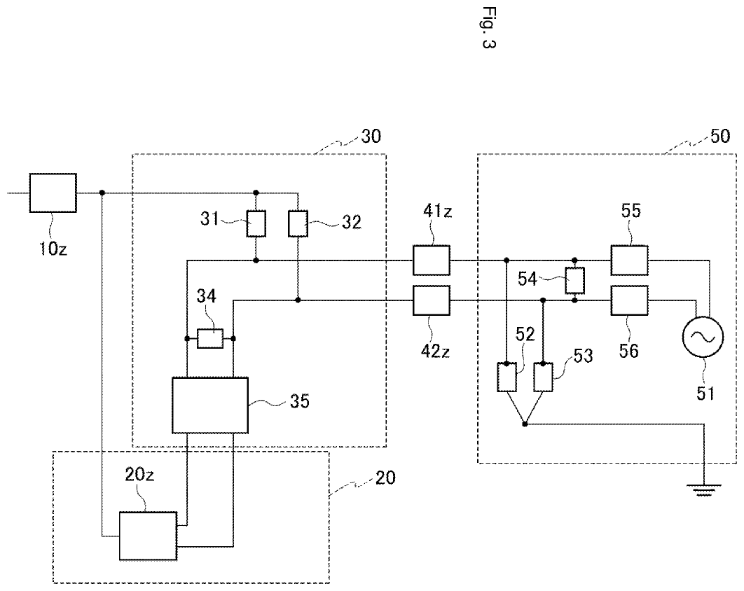

FIG. 3 is a diagram illustrating another example of the connection relationship between the Faraday cage 10 and the power supply device 50. FIG. 3 is different from FIG. 2 in that the power transmission coil 33 and the power reception coil 21 are changed to the filter 35.

As illustrated in FIG. 3, the power necessary for the flight of the flight object 20 may be supplied via the filter 35. The filter 35 is a filter that blocks the frequency component of the lightning surge similarly to the filters 55 and 56. Since the filter 35 is interposed in the power supply path, the impedance viewed from the Faraday cage 10 is larger on the flight object 20 side than on the first and second voltage-dependent switches 31 and 32 side.

Thus, the lightning surge is guided to ground via the first voltage-dependent switch 31 and the third voltage-dependent switch 52, or the second voltage-dependent switch 32 and the fourth voltage-dependent switch 53. Accordingly, the flight object 20 is prevented from being damaged by the lightning surge.

As described above, the lightning guiding system 100 according to the present embodiment includes a flight object 20 included in a Faraday cage 10, a power supply unit 30 included in the Faraday cage 10 and supplies power to the flight object 20, a first voltage-dependent switch 31 connected between the Faraday cage 10 and the one 41 of power supply lines 40 that supplies power to the power supply unit 30, a second voltage-dependent switch 32 connected between the Faraday cage 10 and the other 42 of power supply lines 40, a power supply device 50 provided at an end of the power supply line 40 on the ground surface 2 side, a third voltage-dependent switch 52 connected between one output terminal of the power supply device 50 and the ground, and a fourth voltage-dependent switch 53 connected between the other output terminal of the power supply device 50 and the ground. As a result, it is possible to provide a lightning guiding system that suppresses a current due to a lightning surge flowing through the flight object 20 (drone) and prevents the flight object 20 from being damaged or dropped.

### (Lightning Guiding Method)

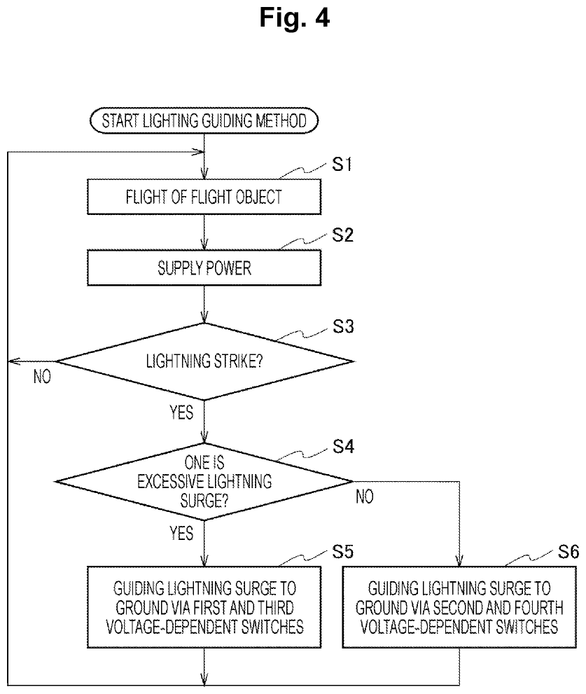

FIG. 4 is a flowchart illustrating a processing procedure of a lightning guiding method performed by the lightning guiding system 100. A lightning guiding method according to the present embodiment will be described with reference to FIG. 4.

The lightning guiding system 100 causes the flight object 20 included in the Faraday cage 10 to fly (step S1). The flight object 20 flies under the control of an operator on the ground.

Power necessary for the flight of the flight object 20 is supplied from the power supply device 50 on the ground via the power supply line 40 (step S2). Power supply is always continued while the flight object 20 is in flight (NO in step S3).

When lightning strikes the Faraday cage 10 in flight (YES in step S3) and an excessive lightning surge is applied to the one of the supply lines 41 (YES in step S4), the lightning surge is guided to ground via the first voltage-dependent switch 31 and the third voltage-dependent switch 52 (step S5).

Alternatively, when an excessive lightning surge is applied toward the other supply line 42 (NO in step S4), the lightning surge is guided to ground via the second voltage-dependent switch 32 and the fourth voltage-dependent switch 53 (step S6).

As described above, the lightning guiding method according to the present embodiment includes causing a flight object 20 to fly between a lightning originating point 1 in midair where lightning occurs and a ground surface 2, supplying power to the flight object 20 by a power supply unit 30, guiding a lightning surge from lightning that has struck a Faraday cage 10 including the flight object 20 and the power supply unit 30 to ground via a first voltage-dependent switch 31 connected between the Faraday cage 10 and one of power supply lines 40 that supply power to the power supply unit 30 and a third voltage-dependent switch 52 connected between the one of the power supply lines 40 and the ground, or guiding the lightning surge to the ground via a second voltage-dependent switch 32 connected between another of the power supply lines 40 supplying power to the power supply unit 30 and a fourth voltage-dependent switch 53 connected between the other of the power supply lines 40 and the ground. Therefore, it is possible to provide a lightning guiding method for suppressing the current caused by the lightning surge flowing through the flight object 20 (drone) and prevents the flight object 20 from being damaged or falls.

Note that, since the flight object 20 is always supplied with power from the power supply device 50, there is no back-and-forth between the ground and the air of the flight object 20, and thus it is possible to efficiently capture a lightning strike. In addition, since the lightning surge does not pass through the flight object 20, it is possible to reduce a failure of the flight object 20.

In addition, the flight object 20 does not need to be equipped with a large-capacity battery, and thus flight object 20 can be reduced in weight. In addition, since the flight object 20 and the power supply device 50 are connected only by the power supply line 40, an activity range of the flight object 20 can be widened. That is, since the power supply line 40 also functions as a conventional guide line, the load on the flight object 20 can be reduced.

Note that, in the above embodiment, an example has been described in which power is supplied to the flight object 20 by a magnetic field coupling method using an alternating current, but the present invention is not limited to this example. The secondary battery built in the flight object 20 may be charged with a DC power supply. Further, the shape of the Faraday cage 10 is not necessarily a sphere.

As described above, the present invention of course includes various embodiments and the like not described herein. Therefore, the technical scope of the present invention is defined only by matters to specify the invention according to the scope of claims pertinent based on the foregoing description.

### REFERENCE SIGNS LIST

1 Lightning originating point
2 Ground surface
10 Faraday cage
11 Pillar
20 Flight object
21 Power reception coil
30 Power supply unit
31 First voltage-dependent switch
32 Second voltage-dependent switch
33 Power transmission coil
34 Sixth voltage-dependent switch
40 Power supply line
41 One supply line
42 One supply line
50 Power supply device
51 Power supply
52 Third voltage-dependent switch
53 Fourth voltage-dependent switch
54 Fifth voltage-dependent switch

1. A lightning guiding system comprising:
a flight object that is included in a Faraday cage;
a first power supply circuit that is included in the Faraday cage and supplies power to the flight object;
a first voltage-dependent switch that is connected between the Faraday cage and one of power supply lines for supplying power to the first power supply circuit;
a second voltage-dependent switch that is connected between the Faraday cage and another of the power supply lines;
a second power supply circuit that is provided at an end portion of the power supply line on a ground surface side;
a third voltage-dependent switch that is connected between one output terminal of the second power supply circuit and the ground; and
a fourth voltage-dependent switch that is connected between another output terminal of the second power supply circuit and the ground.

2. The lightning guiding system according to claim 1, further comprising:
a fifth voltage-dependent switch that is connected between the one and the other of the power supply lines; and
a sixth voltage-dependent switch that is connected between the output terminals.

3. The lightning guiding system according to claim 1, wherein the flight object and the Faraday cage are connected via an insulator.

4. The lightning guiding system according to claim 1, wherein the flight object is supplied with power from the first power supply circuit via an electric power line.

5. The lightning guiding system according to claim 1, wherein the flight object is supplied with power from the first power supply circuit via a filter.

6. A lightning guiding method comprising:
causing a flight object to fly between a lightning originating point in midair where lightning occurs and a ground surface;
supplying power to the flight object by a first power supply circuit; and
guiding a lightning surge
i) from lightning that has struck a Faraday cage including the flight object and the first power supply circuit to the ground via a first voltage-dependent switch connected between the Faraday cage and one of power supply lines that supply power to the first power supply circuit and a third voltage-dependent switch connected between the one of the power supply lines and the ground; or
ii) to the ground via a second voltage-dependent switch connected between another of the power supply lines supplying power to the power supply and a fourth voltage-dependent switch connected between the other of the power supply lines and the ground.
